(19) United States
(12) Patent Application Publication
(10) Pub. No.: US 2023/0161326 A1
(43) Pub. Date: May 25, 2023

(54) Method for Monitoring and/or Controlling a Production Plant

(71) Applicant: BASF SE, Ludwigshafen am Rhein (DE)

(72) Inventor: Erik Wiegert, Mannheim (DE)

(21) Appl. No.: 17/920,080

(22) PCT Filed: Apr. 13, 2021
(86) PCT No.: PCT/EP2021/059566

§ 371 Date: Oct. 20, 2022

(30) Foreign Application Priority Data
Apr. 22, 2020 (EP) 20170840.1

(51) Int. Cl. G05B 19/4155

(52) U.S. Cl. CPC G05B 19/4155; G05B 2219/32361

(57) ABSTRACT

The present invention is in the field of computer-implemented methods for monitoring and/or controlling a production plant based on customer expectations. The present invention relates to a computer-implemented method for monitoring and/or controlling a production plant comprising (a) providing expectation data related to customer expectation, (b) providing plant data related to the operation of a production plant, (c) providing the expectation data and the plant data to a model suitable for extracting instructions based on a predicted customer satisfaction, and (d) outputting the instructions received from the model.

The present invention is in the field of computer-implemented methods for monitoring and/or controlling a production plant based on customer expectations.

Customers in the business-to-business (B2B) market have quite different expectations for their suppliers depending on their need. For example, some customers need a product with a quality to be exactly within a given specification, because otherwise their own production runs into trouble, for example because a machine stops due to congestion. Others may be more tolerant in this respect but require a special packaging for their processing.

Often, supply chain operators together with sales teams try to match the needs of their customers simply by manually reacting to complaints or other customer feedback. However, this usually results in a bad customer satisfaction due to decreased productivity with their own facilities. Also, if the production faces difficulties, for example due to contaminations or machine failure, it gets challenging to meet expectation of customers. It is therefore desirable to provide a solution which increases productivity both for the producer as well as for the customer.

JP 2006/119759 A discloses a system to predict customer satisfaction from questionnaires which the customers have completed. This system serves to design a product including a price. However, no action to manage a production process is provided, so this system is not suitable for reacting to productions conditions.

CN 109 377 252 A discloses a method for predicting customer satisfaction based on a big data approach. However, the method does not provide any action to manage the production process, so this system is also not suitable for reacting to productions conditions.

The object of the present invention is to increase the productivity of both the production plant and the customer and thereby to increase the customer satisfaction. The method should be applicable in a broad variety of production processes and should be technically scalable. It was aimed at a method which can quickly react to changes and involves a minimum of additional personnel, ideally existing resources are used.

These objects where achieved by a computer-implemented method for monitoring and/or controlling a production plant comprising

(a) providing expectation data related to customer expectation,
(b) providing plant data related to the operation of a production plant,
(c) providing the expectation data and the plant data to a model suitable for extracting instructions based on a predicted customer satisfaction, and
(d) outputting the instructions received from the model.

The present invention further relates to a non-transitory computer readable data medium storing a computer program including instructions for executing steps of the method according to the present invention.

The present invention further relates to a production monitoring and/or control system for monitoring and/or controlling a production plant comprising

(a) an input unit configured to receive expectation data related to customer expectation and plant data related to the operation of a production plant,
(b) a processing unit configured to extract instructions based on a predicted customer satisfaction from the expectation data and the plant data,
(c) an output unit configured to output the instructions received from the model.

Preferred embodiments of the present invention can be found in the description and the claims. Combinations of different embodiments fall within the scope of the present invention.

### BRIEF DESCRIPTION OF THE FIGURES

FIG. 1 shows a potential implementation of the invention.

FIG. 2 shows another potential implementation of the invention.

The present invention relates to a method for monitoring and/or controlling a plant. Monitoring generally means the observation and recording of any state of operation of the plant. The state of operation includes internal parameters, i.e. those parameters which are solely relevant within the plant such as a reactor temperature, pressure, electricity consumption, input or output material flows, rotational speeds of stirrers, states of valves, concentrations of vapors in the air within the plant, number of people inside the plant. The state of operation also includes external parameters, i.e. parameters which relate to any exchange with the environment of the plant, such as emission of chemical vapors, heat, sound, vibrations, light. Recording can mean storing the raw data onto a permanent data storage device or preparing documents in a format which are required by the company, customers or by authorities.

Controlling generally means taking any actions to change the state of operation of the plant. The actions can be direct, for example by changing the state of a valve, changing the temperature by additional heating or increasing the cooling. The actions can also be indirect, for example by prompting an operator to take actions, for example exchanging a filter or adjusting throughput.

A production plant is any facility which is able to produce any kind of good which is sold to a customer or further processed in a different plant. Examples for plants are power plants, steel manufacturing plants, oil producing plants, oil refineries, chemical plants, plants for manufacturing pharmaceuticals, plants for manufacturing construction materials, machine manufacturing plants, automobile manufacturing plants, plants for manufacturing textiles, plants for manufacturing furniture, food production plants, plants for manufacturing consumer electronics such as cell phones, plants for manufacturing and/or processing of paper, such as a printing press.

The method according to the present invention comprises (a) providing expectation data related to customer expectation. Customer expectation is any parameter which influences to the customer satisfaction with the product. Such parameters include properties of the product, for examples its overall quality, differences between multiple pieces of the product, or its packaging. Such parameters can also relate to the logistics for the product, such as the time between order and delivery, tracking options, individual labelling, choice of third-party logistics provider, or bundling of delivery of multiple products. Such parameters can also relate to additional information and/or documentation about the product such as environmental impact of the production or the delivery, compliance with religious standards, such as halal or kosher, compliance with requirements with labels such as labels for ecological standards or fair-trade labels, potential contact with other substances in the plant or the shipping process, temperature during shipping, or instructions for the use of the product.

Expectation data can have various sources. Expectation data can be obtained from direct communication with customers, for example previous complaints, input from marketing and salespeople, comments from the customer in the order, feedback questionnaires, documentation from customer support. Also, more sophisticated sources for expectation data are conceivable, for example data-driven models which have been trained with previous customer data and their expectation. Previous customer data may include data from all customers having bought the same or similar products or be restricted to certain customers similar to the one in question, for example operating in the same business field or having a similar size or order volume. The model may then predict customer expectation which is particularly useful for new customers for which little is known. It is also possible to screen comment sections on sales platforms or social media for comments related to the sold product or similar products of competitors in order to extract customer expectations. Preferably, the expectation data is provided from multiple different sources, such as at least two, more preferably at least three, in particular at least four. In this case, the data obtained from multiple sources is preferably preprocessed in order to bring it into the same format and eliminate duplicates or contradictory data.

The expectation data may be provided through an interface. It may be provided to the interface by a user interface. The user interface may be adapted to receive such data from persons having contact with the customer, such as salespeople or customer support. It is also possible to provide the expectation data through an interface to a customer portal which allows the customer to enter expectation data, for example general wishes, feedback on previous deliveries, or details about his own processes. Preferably, the expectation data is provided through an interface to multiple systems for collecting expectation data, for example to at least two, three, or four. The data may have to be converted into a uniform format, either before being provided through the interface or after. The systems may be on the computer the method of the present invention is executed on or, more often, on remote servers either on the company site or those of a cloud service provider. The servers are connected to the computer executing the method according to the present invention by a communication interface, for example by a company-internal intranet or via the internet.

The method according to the present invention comprises (b) providing plant data related to the operation of a production plant. The operation of the production plant is any parameter of the production plant which has an influence on the product, including its quality, its availability, or time needed to produce a certain amount of it. These parameters may have a direct influence on the product, for example an interruption of the production will increase the time for delivery of a product or the temperature in a reactor may influence the quality of the product. The parameters may also have an indirect influence on the product, for example the operation time of a filter may indicate a soon interruption of the production.

Examples for plant data is information about current throughputs, stock levels for raw materials, intermediates or products, current delivery time for raw material supply, current setup of production equipment which can be used to produce different products, analytical data of raw materials, intermediates or products, either from quality management or from supplier material data sheets, plans about past and scheduled maintenance, age of wear parts, order lists including amounts and specifications of ordered products, utilization of production equipment capacity, availability of employees, e.g. due to vacation, illness, off-site training or excess overtime, rate of discarded products, e.g. due to failure of meeting specifications, current delivery time for raw materials or supply parts for production equipment.

The plant data may be provided through an interface. It may be provided through an interface to a user interface. The user interface may be adapted to receive such data from persons in the plant, such as the plant manager or the person in charge for logistics. Preferably, however, the plant data is provided through an interface to a system comprising sensors and a unit to process the sensor signals into plant data and/or to an enterprise resource planning system. The data may have to be converted into a uniform format, either before being provided through the interface or after.

The method according to the present invention comprises (c) providing the expectation data and the plant data to a model suitable for extracting instructions based on a predicted customer satisfaction. The model is preferably a data-driven model. A data-driven model is a trained mathematical model which is parametrized according to training data to input expectation data and plant data and output instructions for monitoring and/or controlling a plant. The data-driven model is preferably a data-driven machine learning model. The data-driven model can be a linear or polynomial regression, a decision tree, a random forest model, a Bayesian network or a neural network. The data-driven model can be a supervised machine learning model or an unsupervised machine learning model. Supervised machine learning models are usually useful for predicting customer expectations based on historical data. Unsupervised machine learning models are usually useful for detecting irregularities in the plant operation. Hence, it is preferable to combine a supervised machine learning model and an unsupervised machine learning model.

The model is designed to maximize the expected customer satisfaction. The customer satisfaction for the training data can be obtained from direct feedback from the customers, e.g. from a feedback questionnaire or interviews with the customer. The customer satisfaction can also include reaction data from the customer, for example the complaint rate, the frequency of customer support requests, the subsequent order behavior, comments in social networks, reactions to marketing and salespeople. Preferably, the customer satisfaction takes into account multiple of these, i.e. at least two. Maximizing the customer satisfaction can mean maximizing the customer satisfaction for each customer separately, maximizing the customer satisfaction of groups of customers, maximizing the average customer satisfaction for all customers or maximizing a weight average customer satisfaction. Preferably, a weight average customer satisfaction is maximized. Weighing can, for example be done with regard to the order volume of each customer, the frequency of orders, or strategic aspects such as the importance of the industry sector of the customer or expected future order volumes.

Maximizing the customer satisfaction both has a commercial effect, i.e. higher chances for future orders, increased reputation leading to potentially higher prices etc. But it also has technical effects on the plant. For example, it decreases waste as a result of a customer complaint returning products, increases energy efficiency as the plant can be operated in the most energy-efficient way without negative customer reactions, or reduces resources, in particular manual operations of personnel, for customer support.

The model is suitable for extracting instructions from the expectation data and the plant data. The instructions are aimed at increasing the customer satisfaction if completed. Various instructions are conceivable. The instruction may relate to retrieving a piece of information and forward it to the customer. As an example, the model may have detected a delay in the production process and extracted the instruction to inform the customer about the delay. Another example is that the model detects expiration of a certificate and extracts the instruction to renew the certificate and/or send the new certificate to the customers who need it. The instruction may relate to an action to reassign the product to the orders by the customers. For example, the model has detected a deviation in the production parameters leading to a different quality and extracts the instruction to assign the thus obtained products to customers which have less strict expectations to quality. Another example is that the model has detected a potential contamination due to handling of a different substance which is not accepted by some customers and extracted the instruction to assign the thus produced products only to customers which are more tolerant in this respect, for example because they use the product for a less demanding application. Another example is that the model has detected a real or an expected delay in the production and extracted the instruction to send the just produced products to the customers with the highest expectation for on-time delivery, for example for customers known or expected to have very limited storage capacity. The instruction may also relate to an action to adjust production parameters. For example, it may be possible to increase material flows to increase the output of production as the price of a lower quality. If the customer expectation indicates a higher priority towards quick delivery, the instruction may be to increase the material flows. If the customer expectation indicates a higher priority towards high quality, the instruction may be to decrease the material flows.

Preferably, the model is provided with information from the ordering system. For example, an order information may contain the customer, the date of order, the product, the quantity, the quality, the packaging. The model is preferably adapted to take this order information into account when generating the instruction. In this way, an instruction can be specific for a particular order, for example the model may generate the instruction to inform the customer about the availability of a certain packaging type for this particular order or an expected delivery date.

The instructions typically contain object and an action related to the object. The instruction can preferably contain a reason why to take that action, for example the piece of plant data leading to the action. The instruction can preferably contain time information, for example a period within which the action should be taken. The instruction can preferably contain a classification for impact on the customer satisfaction in order to enable a prioritization of multiple instructions. The instructions are preferably in a computer-readable format, in particular in a format which can be automatically processed by system, such as a logistics system.

The method according to the present invention comprises (d) outputting the instructions received from the model. Outputting can mean writing the instructions on a non-transitory data storage medium, display it on a user interface or transmit it to a control unit which puts the instructions into physical action. Preferably, the instructions are output by displaying it on a user interface. The user interface is preferably adapted to receive from a user, for example the plant operator, a selection, a modification, a prioritization, or a date for execution for each or a group of instructions. The instructions with the associated user input may be stored on a permanent storage medium or transmitted to a control unit. Preferably, the instructions are stored to a database in order to make them accessible for later evaluation if the customer satisfaction has actually been achieved.

Preferably, the user interface is adapted to receive a feedback about the customer satisfaction for each instruction. This information can be used to further improve the model. Such improvements can be done batchwise, i.e. after collecting feedback for a certain time, or, preferably, continuously, i.e. each time a new feedback is collected the model is updated in order to be able to quickly react to changes. For the same purpose, the model may be repeatedly trained, wherein more recent feedback has more impact on the model than older feedback.

The present invention further relates to a non-transitory computer readable data medium storing a computer program including instructions for executing steps of the method according to the present invention. Computer readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system.

The present invention further relates to a production monitoring and/or control system for monitoring and/or controlling material properties of a sample. Unless explicitly described differently hereafter, the description relating to the method including preferred embodiments also applies to the system. The system can be a computing device, for example a computer, tablet, or smartphone. Often the computing device has a network connection in order to communicate with other computing devices, such as servers or a cloud network.

The production monitoring and/or control system according to the present invention comprises (a) an input unit configured to receive expectation data related to customer expectation and plant data related to the operation of a production plant. Preferably the input unit comprises an interface to a user interface which allows the user to input expectation data. Preferably the input unit comprises an interface to an enterprise resource planning software allowing the retrieval of information such as order lists, delivery status, production volumes or order volumes for raw materials. Preferably, the input unit is configured to receive information about the plant, for example from sensors or a control system. Preferably, the input unit has an interface to a customer feedback system. Such a customer feedback system may be a standalone portal for just the purpose of inserting and processing customer feedback. A customer feedback system may also be part of an order and/or delivery system. The input unit may be implemented as a webservice or a standalone software package. The input unit may form the presentation or application layer.

The production monitoring and/or control system according to the present invention comprises (b) a processing unit configured to extract instructions based on a predicted customer satisfaction from the expectation data and the plant data. The processing unit may be a local processing unit comprising a central processing unit (CPU) and/or a graphics processing units (GPU) and/or an application specific integrated circuit (ASIC) and/or a tensor processing unit (TPU) and/or a field-programmable gate array (FPGA). The processing unit may also be an interface to a remote computer system such as a cloud service.

The production monitoring and/or control system according to the present invention comprises (c) an output unit configured to output the instructions received from the model. The output unit may be implemented as a webservice or a standalone software package. The output unit may form the presentation or application layer. Preferably the output unit comprises a user interface which is configured to display the instructions for the plant. The user may then take the necessary action, for example adjust production parameters or collect sensor data. Preferably, the user interface is configured to receive feedback from the user about the instructions which can be used to further train the model. Alternatively, the output unit may include or have an interface to an apparatus which automatically adjusts production parameters or collects sensor data. Also, preferably, the output unit comprises an interface to a system adapted to send information to the customer based on the instructions received from the model. Preferably, the output unit has an interface to a database to store the instructions in the database, for example a relational database or a graph database.

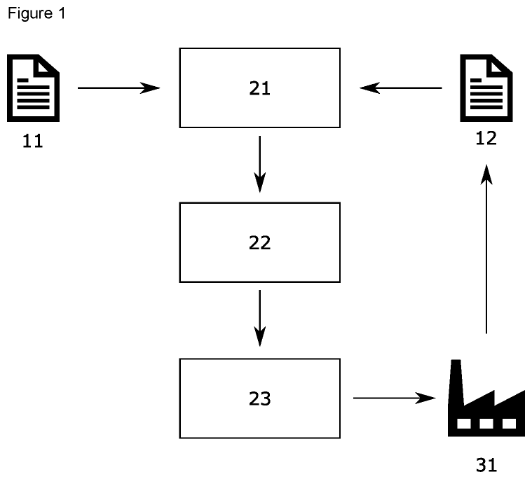

Various implementations of the invention are conceivable. FIG. 1 shows a potential implementation. Expectation data 11 and plant data 12, which are obtained from plant 31 are provided to an input unit 21. The input unit 21 forwards the data to a processing unit 22 which extracts instructions based on a predicted customer satisfaction from the expectation data and the plant data. An output unit 23 outputs the instructions obtained from the model and may forward these instructions to the plant 31, where the necessary actions according to these instructions are either performed automatically or by a plant operator.

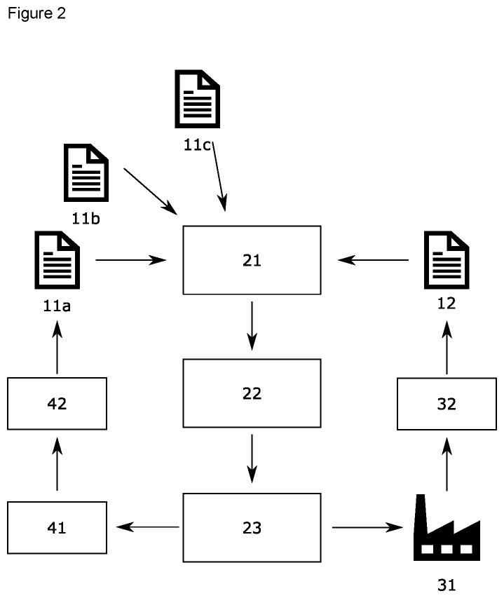

FIG. 2 shows another potential implementation. Expectation data 11a, 11b, 11c is provided to the input unit 21 from various sources, for example expectation data 11a is provided from a customer feedback system 42 which receives feedback from a customer system 41. Plant data 12 is also provided to the input unit 21, wherein the plant data may be obtained from a processing unit 32 which receives sensor signals from the plant and processes these into plant data. The input unit 21 forwards the data to a processing unit 22 which extracts instructions based on a predicted customer satisfaction from the expectation data and the plant data. An output unit 23 outputs the instructions obtained from the model and may forward these instructions either to the plant 31 and/or to the customer system 41 which provides the customer with any required information. The customer system may, depending on the reaction of the customer to such information, provide the customer feedback system 42 with such feedback related to an instruction obtained from the model. In such a way, the model may be further improved for future instruction generation.

1. A computer-implemented method for monitoring and/or controlling a production plant comprising:
(a) providing expectation data related to customer expectation,
(b) providing plant data related to the operation of a production plant,
(c) providing the expectation data and the plant data to a model suitable for extracting instructions based on a predicted customer satisfaction, and
(d) outputting the instructions received from the model.

2. The computer-implemented method according to claim 1, wherein at least parts of the plant data is provided through an interface to an enterprise resource planning system.

3. The computer-implemented method according to claim 1, wherein the model is a data-driven machine learning model.

4. The computer-implemented method according to claim 1, wherein the model is a combination of a supervised machine learning model and an unsupervised machine learning model.

5. The computer-implemented method according to claim 1, wherein the model maximizes a weight average customer satisfaction.

6. The computer-implemented method according to claim 1, wherein the model is provided with information from the ordering system.

7. The computer-implemented method according to claim 1, wherein the instructions are output onto a user interface.

8. The computer-implemented method according to claim 1, wherein the expectation data is provided from at least three different sources.

9. The computer-implemented method according to claim 7, wherein the user interface is adapted to receive a feedback about the customer satisfaction for each instruction to improve the model.

10. A non-transitory computer readable data medium storing a computer program including instructions for executing steps of the method according to claim 1.

11. A production monitoring and/or control system for monitoring and/or controlling a production plant comprising:
(a) an input unit configured to receive expectation data related to customer expectation and plant data related to the operation of a production plant,
(b) a processing unit configured to extract instructions based on a predicted customer satisfaction from the expectation data and the plant data,
(c) an output unit configured to output the instructions received from the model.

12. The production monitoring and/or control system according to claim 11, wherein input unit comprises a user interface which allows the user to input expectation data.

13. The production monitoring and/or control system according to claim 11, wherein the input unit has an interface to a customer feedback system.

14. The production monitoring and/or control system according to claim 11, wherein the output unit comprises a user interface which is configured to display the instructions for the plant.

15. The production monitoring and/or control system according to claim 11, wherein the output unit comprises an interface to a system adapted to send information to the customer based on the instructions received from the model.
